(19) United States
(12) Patent Application Publication
(10) Pub. No.: US 2026/0358968 A1
(43) Pub. Date: Nov. 12, 2026

(54) MEMORY SYSTEM WHERE A MEMORY CONTROLLER IS INFORMED WHICH MEMORY RANK IS TO BE ACCESSED IN ADVANCE

(71) Applicant: MEDIATEK INC., Hsinchu City (TW)

(72) Inventors: Chih-Chieh Chang, Hsinchu City (TW); Hsiu-Chieh Hung, Hsinchu City (TW)

(73) Assignee: MEDIATEK INC., Hsinchu City (TW)

(21) Appl. No.: 19/203,209

(22) Filed: May 9, 2025

(51) Int. Cl. G06F 3/06

(52) U.S. Cl. CPC G06F 3/0625; G06F 3/0634; G06F 3/0659; G06F 3/0673

(57) ABSTRACT

A memory system includes an external memory interface, a system-level cache and a memory controller. The external memory interface can receive a first signal from a master device and convert the first signal to a second signal. The system-level cache can be coupled to the external memory interface and store data to be accessed according to the second signal and send a third signal according to the second signal. The memory controller can be coupled to the system-level cache and receive the third signal and a fourth signal and send a control signal according to the fourth signal to enable one of a first memory rank and a second memory rank to enter a standby mode and perform a clock synchronization operation before accessing memory data by the memory controller.

### BACKGROUND

As applications of electronic devices become more complex, the memory requirements are also increasing. In order to store more data, it is insufficient to use memories with single memory rank. Therefore, in an electronic device, it is often necessary to use a memory with multiple memory ranks.

However, technical problems were found in practice. Since it is difficult to detect in advance which memory rank is to be accessed, using a memory with two memory ranks results in longer latency, and it is difficult to manage power consumption of the memory.

### SUMMARY

An embodiment provides a memory system including a central external memory interface, a system-level cache, a channel external memory interface and a memory controller. The central external memory interface is configured to convert a first signal from a master device to a second signal. The central external memory interface includes a first terminal coupled to the master device and configured to receive the first signal, and a second terminal configured to send the second signal. The system-level cache is configured to store data to be accessed according to the second signal. The system-level cache includes a first terminal coupled to the central external memory interface for receiving the second signal, a second terminal for sending a third signal corresponding to the second signal, and a third terminal for sending a fourth signal corresponding to the second signal. The channel external memory interface is configured to generate a fifth signal according to at least the third signal. The channel external memory interface includes a first terminal coupled to the system-level cache for receiving the third signal, and a second terminal for sending the fifth signal. The memory controller is configured to send a control signal to enable one of a first memory rank and a second memory rank to enter a standby mode and perform a clock synchronization operation before accessing memory data by the memory controller. The memory controller includes a first terminal coupled to the channel external memory interface for receiving the fifth signal, a second terminal coupled to the system-level cache for receiving the fourth signal, and a third terminal coupled to the first memory rank and the second memory rank for sending the control signal according to the fourth signal. The fourth signal is used to inform the memory controller which one of the first memory rank and the second memory rank is to be accessed before the memory controller receives the fifth signal. The fifth signal contains an address of data in the first memory rank or the second memory rank to be accessed by the memory controller.

Another embodiment provides a memory system including a central external memory interface, a system-level cache, a channel external memory interface, and a memory controller. The central external memory interface is configured to convert a first signal from a master device to a second signal and a third signal. The central external memory interface includes a first terminal for receiving the first signal, a second terminal for sending the second signal, and a third terminal for sending the third signal. The system-level cache is configured to store data to be accessed according to the second signal. The system-level cache includes a first terminal coupled to the central external memory interface for receiving the second signal, and a second terminal for sending a fourth signal corresponding to the second signal. The channel external memory interface is configured to generate a fifth signal according to at least the fourth signal. The channel external memory interface includes a first terminal coupled to the system-level cache for receiving the fourth signal, and a second terminal for sending the fifth signal. The memory controller is configured to send a control signal to enable one of a first memory rank and a second memory rank to enter a standby mode and perform a clock synchronization operation before accessing memory data by the memory controller. The memory controller includes a first terminal coupled to the channel external memory interface for receiving the fifth signal, a second terminal coupled to the central external memory interface for receiving the third signal, and a third terminal coupled to the first memory rank and the second memory rank for sending the control signal according to the third signal. The third signal is used to inform the memory controller which one of the first memory rank and the second memory rank is to be accessed before the memory controller receives the fifth signal. The fifth signal contains an address of data in the first memory rank or the second memory rank to be accessed by the memory controller.

Another embodiment provides a memory system including a central external memory interface, a system-level cache, a channel external memory interface, and a memory controller. The central external memory interface is configured to convert a first signal from a master device to a second signal. The central external memory interface includes a first terminal for receiving the first signal, and a second terminal for sending the second signal. The system-level cache is configured to store data to be accessed according to the second signal. The system-level cache includes a first terminal coupled to the central external memory interface for receiving the second signal, and a second terminal for sending a third signal corresponding to the second signal. The channel external memory interface is configured to generate a fourth signal according to at least the third signal. The channel external memory interface includes a first terminal coupled to the system-level cache for receiving the third signal, and a second terminal for sending the fourth signal. The memory controller is configured to send a control signal to enable one of a first memory rank and a second memory rank to enter a standby mode and perform a clock synchronization operation before accessing memory data by the memory controller. The memory controller includes a first terminal coupled to the channel external memory interface for receiving the fourth signal, a second terminal coupled to the master device for receiving a fifth signal, and a third terminal coupled to the first memory rank and the second memory rank for sending the control signal according to the fifth signal. The fifth signal is used to inform the memory controller which one of the first memory rank and the second memory rank is to be accessed before the memory controller receives the fourth signal. The fourth signal contains an address of data in the first memory rank or the second memory rank to be accessed by the memory controller.

Another embodiment provides a memory system including a system-level cache, an external memory interface, and a memory controller. The system-level cache is configured to store data to be accessed according to a first signal from a master device and send a second signal according to the first signal. The external memory interface is coupled to the system-level cache and configured to receive the second signal and send a third signal. The memory controller is coupled to the external memory interface and configured to receive the third signal and send a control signal according to a fourth signal to enable one of a first memory rank and a second memory rank to enter a standby mode and perform a clock synchronization operation before accessing memory data by the memory controller. The system-level cache sends the second signal when the data stored in the system-level cache fails to include required data described in the first signal. The fourth signal is used to inform the memory controller which one of the first memory rank and the second memory rank is to be accessed before the memory controller receives the third signal. The third signal contains an address of data in the first memory rank or the second memory rank to be accessed by the memory controller.

Another embodiment provides a memory system including an external memory interface, a system-level cache, and a memory controller. The external memory interface is configured to receive a first signal from a master device and convert the first signal to a second signal. The system-level cache is coupled to the external memory interface and configured to store data to be accessed according to a first signal from a master device, receive the second signal and send a third signal according to the second signal. The memory controller is coupled to the system-level cache and configured to receive the third signal and send a control signal according to a fourth signal to enable one of a first memory rank and a second memory rank to enter a standby mode and perform a clock synchronization operation before accessing memory data by the memory controller. The system-level cache sends the third signal when the data stored in the system-level cache fails to include required data described in the second signal. The fourth signal is used to inform the memory controller which one of the first memory rank and the second memory rank is to be accessed before the memory controller receives the third signal. The third signal contains an address of data in the first memory rank or the second memory rank to be accessed by the memory controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a memory system coupled to a master device and a dynamic random-access memory according to an embodiment.

FIG. 2 illustrates a memory system coupled to the master device and the dynamic random-access memory according to another embodiment.

FIG. 3 illustrates a memory system coupled to the master device and the dynamic random-access memory according to another embodiment.

FIG. 4 illustrates a memory system coupled to the master device and the dynamic random-access memory according to another embodiment.

FIG. 5 illustrates a memory system coupled to the master device and the dynamic random-access memory according to another embodiment.

FIG. 6 illustrates a memory system coupled to the master device and the dynamic random-access memory according to another embodiment.

FIG. 7 illustrates a memory system coupled to the master device and the dynamic random-access memory according to another embodiment.

### DETAILED DESCRIPTION

A memory can be operated in a high efficiency (HE) mode and a low power (LP) mode. When the memory is operated in the high efficiency mode, the clock signal (e.g. WCK signal) can be always turned ON and the clock synchronization (e.g. WCK2CK sync operation) can be performed until the memory enters a power down (PD) mode. In the high efficiency mode, the two memory ranks in the memory can perform clock synchronization at the same time, and the two memory ranks in the memory can be set in a stand-by mode or a power down mode at the same time.

When the memory is in the low power mode, the clock signal (e.g. WCK signal) can be set OFF after a read operation and/or a write operation is performed, and the clock synchronization (e.g. WCK2CK sync operation) should be performed before a read operation and/or a write operation. The clock synchronization (e.g. WCK2CK sync operation) can be performed until the memory enters a power down (PD) mode. In the low power mode, the two memory ranks in the memory can perform clock synchronization separately, and the two memory ranks in the memory can be set in a stand-by mode or a power down mode separately.

In order to reduce the latency and the power consumption of operating a memory, the following memory systems are introduced.

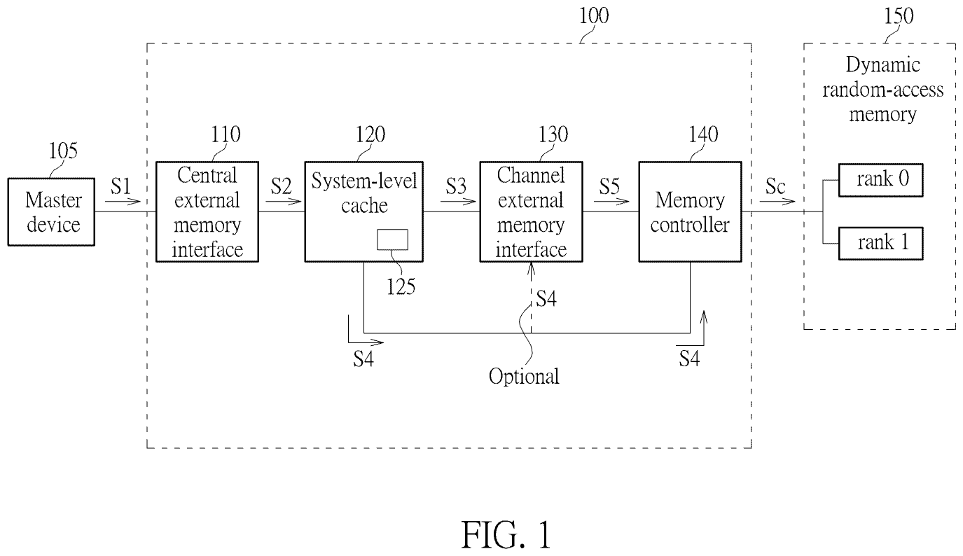

FIG. 1 illustrates a memory system 100 coupled to a master device 105 and a dynamic random-access memory 150 according to an embodiment. The memory system 100 can include a central external memory interface 110, a system-level cache 120, a channel external memory interface 130, and a memory controller 140.

The central external memory interface 110 can be used to convert a first signal S1 from the master device 105 to a second signal S2. For example, the master device 105 can be a processor such as a central processing unit (CPU), a graphical processing unit (GPU), a tensor processing unit (TPU), etc. The central external memory interface 110 can include a first terminal and a second terminal, where the first terminal can be coupled to the master device 105 to receive the first signal S1, and the second terminal can be used to send the second signal S2.

The system-level cache 120 can be used to store data 125 to be accessed according to the second signal S2. The system-level cache 120 can include a first terminal, a second terminal and a third terminal, where the first terminal can be coupled to the central external memory interface 110 and used to receive the second signal, the second terminal can be used to send a third signal S3 corresponding to the second signal S2, and the third terminal can be used to send a fourth signal S4 corresponding to the second signal S2.

The channel external memory interface 130 can be used to generate a fifth signal S5 according to at least the third signal S3. The channel external memory interface 130 can include a first terminal and a second terminal, where the first terminal can be coupled to the system-level cache 120 and used to receive the third signal S3, and the second terminal can be used to send the fifth signal S5.

The memory controller 140 can be used to send a control signal Sc to enable one of a first memory rank rank0 and a second memory rank rank1 to enter a standby mode and perform a clock synchronization operation (e.g. WCK2CK Sync operation) before accessing memory data of a dynamic random-access memory 150 by the memory controller 140. As shown in FIG. 1, the first memory rank rank0 and the second memory rank rank1 can be embedded in the dynamic random-access memory 150.

The memory controller 140 can include a first terminal, a second terminal and a third terminal. The first terminal of the memory controller 140 can be coupled to the channel external memory interface 130 and used to receive the fifth signal S5. The second terminal of the memory controller 140 can be coupled to the system-level cache 120 and used to receive the fourth signal S4. The third terminal of the memory controller 140 can be coupled to the first memory rank rank0 and the second memory rank rank1 and used to send the control signal Sc according to the fourth signal S4.

The fourth signal S4 can be used to inform the memory controller 140 which one of the first memory rank rank0 and the second memory rank rank1 is to be accessed before the memory controller 140 receives the fifth signal S5. The fifth signal S5 can contain an address of data in the first memory rank rank0 or the second memory rank rank1 to be accessed by the memory controller 140.

In FIG. 1, the system-level cache 120 can send the third signal S3 and the fourth signal S4 when the data d1 stored in the system-level cache 120 fails to include required data described in the second signal S2. In other words, the system-level cache 120 can send the third signal S3 and the fourth signal S4 when a “cache miss” event occurs.

As shown in FIG. 1, the channel external memory interface 130 can optionally further include a third terminal coupled to the system-level cache 120 and be used to receive the fourth signal S4. In this structure, the fourth signal S4 can be further used to inform the channel external memory interface 130 which one of the first memory rank rank0 and the second memory rank rank1 is to be accessed, and the fifth signal S5 can be generated according to the third signal S3 and the fourth signal S4.

By using the fourth signal S4 to inform the channel external memory interface 130 and/or the memory controller 140 which one of the first memory rank rank0 and the second memory rank rank1 is to be accessed in advance, the memory rank to be accessed is enabled in advance. As a result, the time for waiting the memory rank to be enabled is reduced, and the latency of the operation is reduced. Consequently the power consumption of the first memory rank rank0 and the second memory rank rank1 is managed more efficiently and flexibly.

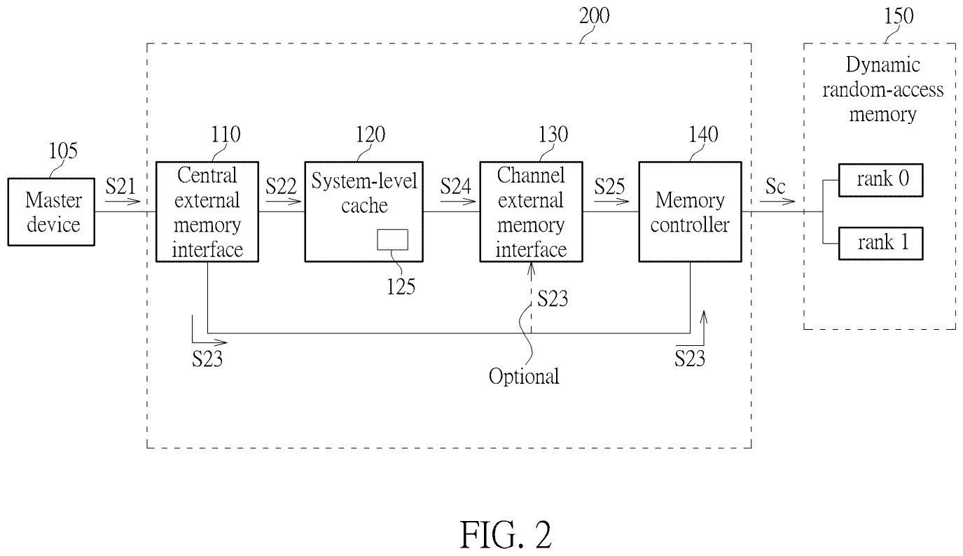

FIG. 2 illustrates a memory system 200 coupled to the master device 105 and the dynamic random-access memory 150 according to another embodiment. The memory system 200 can include a central external memory interface 110, a system-level cache 120, a channel external memory interface 130, and a memory controller 140.

The central external memory interface 110 can be used to convert a first signal S21 from the master device 105 to a second signal S22 and a third signal S23. The central external memory interface 110 can include a first terminal, a second terminal and a third terminal. The first terminal of the central external memory interface 110 can be used to receive the first signal S21. The second terminal of central external memory interface 110 can be used to send the second signal S22. The third terminal of the central external memory interface 110 can be used to send the third signal S23.

The system-level cache 120 can be used to store data 125 to be accessed according to the second signal S22. The system-level cache 120 can include a first terminal and a second terminal. The first terminal of the system-level cache 120 can be coupled to the central external memory interface 110 and used to receive the second signal S22. The second terminal of the system-level cache 120 can be used to send a fourth signal S24 corresponding to the second signal S22.

The channel external memory interface 130 can be used to generate a fifth signal S25 according to at least the fourth signal S24. The channel external memory interface 130 can include a first terminal and a second terminal. The first terminal of the channel external memory interface 130 can be coupled to the system-level cache 120 and used to receive the fourth signal S24. The second terminal of the channel external memory interface 130 can be used to send the fifth signal S25.

The memory controller 140 can be used to send a control signal Sc to enable one of the first memory rank rank0 and the second memory rank rank1 to enter a standby mode and perform a clock synchronization operation (e.g. WCK2CK Sync operation) before accessing memory data of the dynamic random-access memory 150 by the memory controller 140. As shown in FIG. 2, the first memory rank rank0 and the second memory rank rank1 can be embedded in the dynamic random-access memory 150. The memory controller 140 can include a first terminal, a second terminal and a third terminal. The first terminal of the memory controller 140 can be coupled to the channel external memory interface 130 and used to receive the fifth signal S25. The second terminal of the memory controller 140 can be coupled to the central external memory interface 110 and used to receive the third signal S23. The third terminal of the memory controller 140 can be coupled to the first memory rank rank0 and the second memory rank rank1 and used to send the control signal Sc according to the third signal S23.

The third signal S23 can be used to inform the memory controller 140 which one of the first memory rank rank0 and the second memory rank rank1 is to be accessed before the memory controller 140 receives the fifth signal S25. The fifth signal S25 can contain an address of data in the first memory rank rank0 or the second memory rank rank1 to be accessed by the memory controller 140.

In FIG. 2, the system-level cache 120 can send the fourth signal S24 when the data 125 stored in the system-level cache 120 fails to include required data described in the second signal S22. In other words, the system-level cache 120 can send the fourth signal S24 when a “cache miss” event occurs.

The channel external memory interface 130 can optionally further include a third terminal. The third terminal of the channel external memory interface 130 can be coupled to the central external memory interface 110 and used to receive the third signal S23. In this structure, the third signal S23 can be further used to inform the channel external memory interface 130 which one of the first memory rank rank0 and the second memory rank rank1 is to be accessed. The fifth signal S25 can be generated according to the fourth signal S24 and the third signal S23.

By informing the channel external memory interface 130 and/or the memory controller 140 which one of the first memory rank rank0 and the second memory rank rank1 is to be accessed before the memory controller 140 receives the fifth signal S25, the memory rank to be accessed is enabled in advance. As a result, the time for waiting the memory rank to be enabled is reduced, and the latency of the operation is reduced. Consequently the power consumption of the first memory rank rank0 and the second memory rank rank1 is managed more efficiently and flexibly.

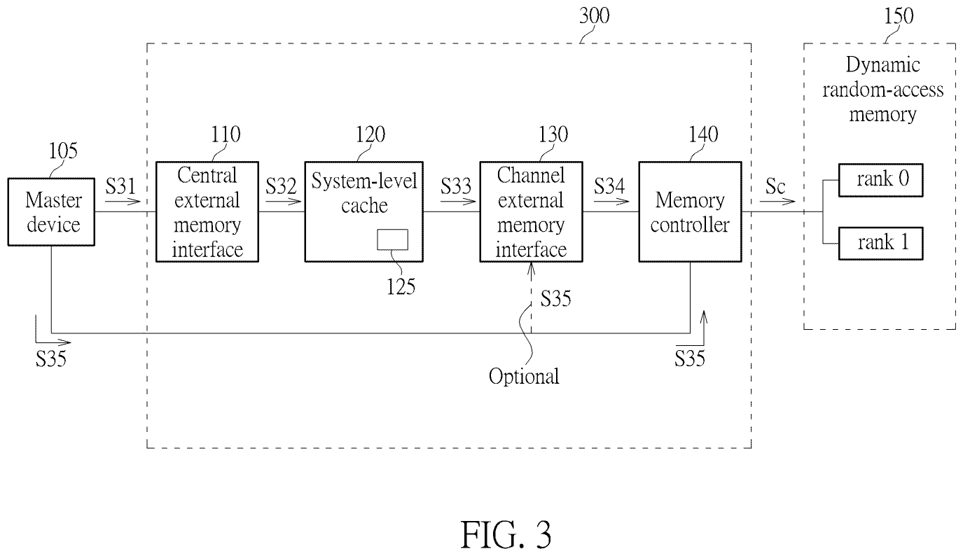

FIG. 3 illustrates a memory system 300 coupled to the master device 105 and the dynamic random-access memory 150 according to another embodiment. The memory system 300 can include a central external memory interface 110, a system-level cache 120, a channel external memory interface 130, and a memory controller 140. In FIG. 3, the central external memory interface 110 is used to convert a first signal S31 from the master device 110 to a second signal S32. The central external memory interface 110 includes a first terminal and a second terminal, where the first terminal can be used to receive the first signal S31, and the second terminal can be used to send the second signal S32.

The system-level cache 120 is used to store data 125 to be accessed according to the second signal S32. The system-level cache 120 can include a first terminal and a second terminal. The first terminal of the system-level cache 120 can be coupled to the central external memory interface 110 and used to receive the second signal S32. The second terminal of the system-level cache 120 can be used to send a third signal S33 corresponding to the second signal S32.

The channel external memory interface 130 used to generate a fourth signal S34 according to at least the third signal S33. The channel external memory interface 130 can include a first terminal and a second terminal, where the first terminal can be coupled to the system-level cache 120 to receive the third signal S33, and the second terminal can be used to send the fourth signal S34.

The memory controller 140 can be used to send a control signal Sc to enable one of the first memory rank rank0 and the second memory rank rank1 to enter a standby mode and perform a clock synchronization operation (e.g. WCK2CK Sync operation) before accessing memory data of the dynamic random-access memory 150 by the memory controller 140. The first memory rank rank0 and the second memory rank rank1 can be embedded in the dynamic random-access memory 150.

The memory controller 140 can include a first terminal, a second terminal and a third terminal. The first terminal of the memory controller 140 can be coupled to the channel external memory interface 130 and used to receive the fourth signal S34. The second terminal of the memory controller 140 can be coupled to the master device 105 and used to receive a fifth signal S35. The third terminal of the memory controller 140 can be coupled to the first memory rank rank0 and the second memory rank rank1 and used to send the control signal Sc according to the fifth signal S35.

In FIG. 3, the fifth signal S35 can be used to inform the memory controller 140 which one of the first memory rank rank0 and the second memory rank rank1 is to be accessed before the memory controller 140 receives the fourth signal S34. The fourth signal S34 can contain an address of data in the first memory rank rank0 or the second memory rank rank1 to be accessed by the memory controller 140.

In FIG. 3, the system-level cache 120 can send the third signal S33 when the data 125 stored in the system-level cache 120 fails to include required data described in the second signal S32. In other words, the system-level cache 120 can send the third signal S33 when a “cache miss” event occurs.

The channel external memory interface 130 can optionally further include a third terminal coupled to the master device 105 and used to receive the fifth signal S35. In this structure, the fifth signal S35 can be further used to inform the channel external memory interface 130 which one of the first memory rank rank0 and the second memory rank rank1 is to be accessed, and the fourth signal S34 can be generated according to the third signal S33 and the fifth signal S35.

By informing the channel external memory interface 130 and/or the memory controller 140 which one of the first memory rank rank0 and the second memory rank rank1 is to be accessed before the memory controller 140 receives the fourth signal S34, the memory rank to be accessed is enabled in advance. As a result, the operation latency is reduced, and the power consumption is better managed.

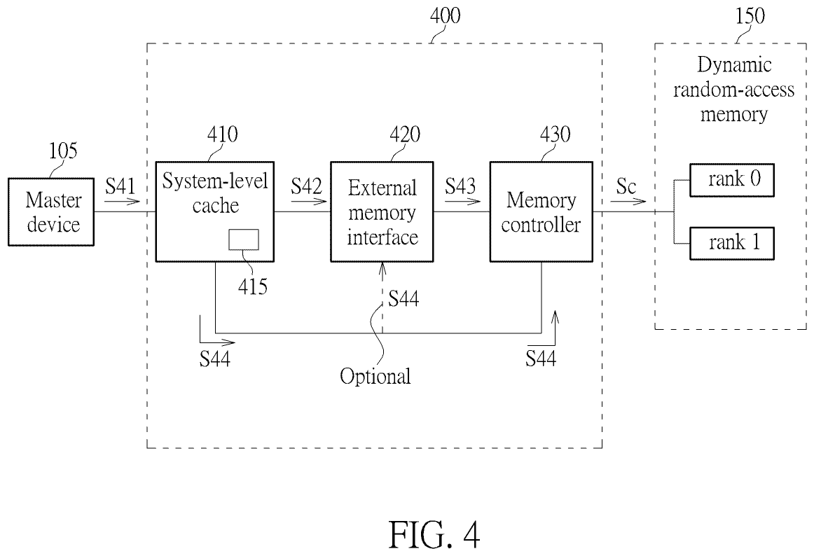

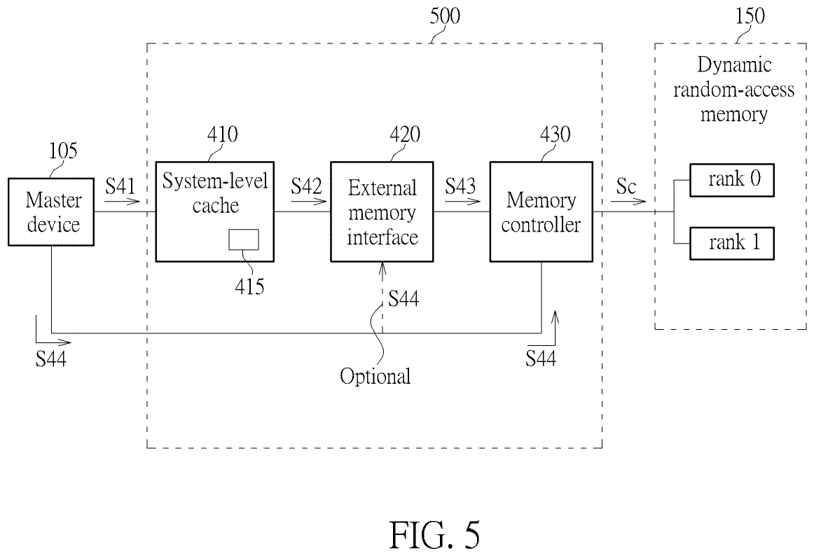

FIG. 4 illustrates a memory system 400 coupled to the master device 105 and the dynamic random-access memory 150 according to another embodiment. FIG. 5 illustrates a memory system 500 coupled to the master device 105 and the dynamic random-access memory 150 according to another embodiment. Each of the memory system 400 and the memory system 500 can include a system-level cache 410, an external memory interface 420 and memory controller 430.

The system-level cache 410 can be used to store data 415 to be accessed according to a first signal S41 from the master device 105 and generate a second signal S42 according to the first signal S41. The external memory interface 420 can be coupled to the system-level cache 410 and used to receive the second signal S42 and generate a third signal S43 according to at least the second signal S42.

The memory controller 430 can be coupled to the external memory interface 420. The memory controller 430 can be used to receive the third signal S43 and a fourth signal S44 and generate a control signal Sc according to the fourth signal S44. The control signal Sc can be used to enable one of the first memory rank rank0 and the second memory rank rank1 of the dynamic random-access memory 150 to enter a standby mode and perform a clock synchronization operation (e.g. WCK2CK Sync operation) before accessing memory data by the memory controller 430.

The system-level cache SLC can send the second signal S42 when the data 415 stored in the system-level cache 410 fails to include required data described in the first signal S41. In other words, system-level cache SLC can send the second signal S42 when a “cache miss” event occurs.

The fourth signal S44 is used to inform the memory controller 430 which one of the first memory rank rank0 and the second memory rank rank1 is to be accessed before the memory controller 430 receives the third signal S43. The third signal S43 can contain an address of data in the first memory rank rank0 or the second memory rank rank1 to be accessed by the memory controller 430.

The fourth signal S44 can be generated by one of the system-level cache 410 and the master device 105. In FIG. 4, the fourth signal S44 can be generated by the system-level cache 410. In FIG. 5, the fourth signal S44 can be generated by the master device 105.

In FIG. 4 and FIG. 5, the fourth signal S44 can be optionally further sent to the external memory interface 420, and the external memory interface 420 can generate the third signal S43 according to the second signal S42 and the fourth signal S44.

By informing the external memory interface 420 and/or the memory controller 430 which one of the first memory rank rank0 and the second memory rank rank1 is to be accessed before the memory controller 430 receives the third signal S43, the memory rank to be accessed is enabled in advance. As a result, the operation latency is reduced, and the power consumption is better managed.

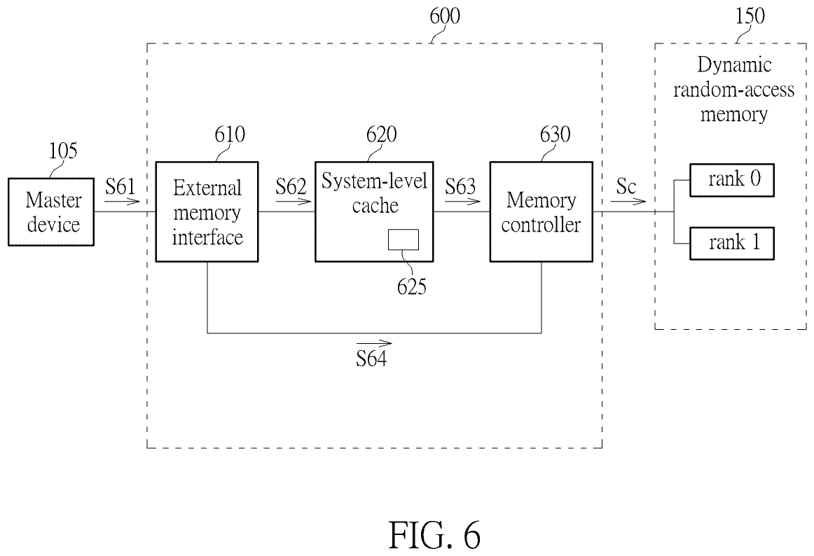

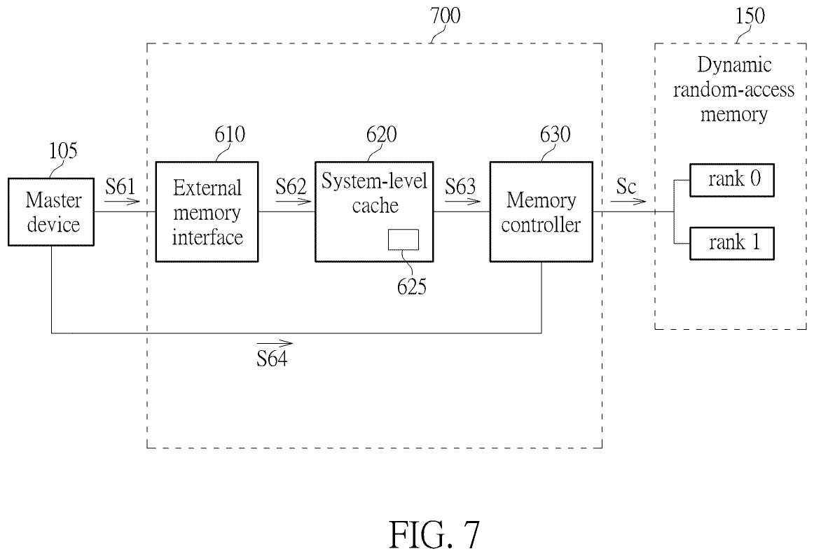

FIG. 6 illustrates a memory system 600 coupled to the master device 105 and the dynamic random-access memory 150 according to another embodiment. FIG. 7 illustrates a memory system 700 coupled to the master device 105 and the dynamic random-access memory 150 according to another embodiment.

Each of the memory system 600 and memory system 700 can include an external memory interface 610, a system-level cache 620, and a memory controller 630. The external memory interface 610 can be used to receive a first signal S61 from the master device 105 and convert the first signal S61 to a second signal S62. The system-level cache 620 can be coupled to the external memory interface 610 and used to store data 625 to be accessed according to the second signal S62 and send a third signal S63 according to the second signal S62.

The memory controller 630 can be coupled to the system-level cache 620 and used to receive the third signal S63 and a fourth signal S64 and send a control signal Sc according to the fourth signal S64 to enable one of the first memory rank rank0 and the second memory rank rank1 to enter a standby mode and perform a clock synchronization operation (e.g. WCK2CK Sync operation) before accessing memory data of the dynamic random-access memory 150 by the memory controller 630.

The system-level cache 620 can send the third signal S63 when the data 625 stored in the system-level cache 620 fails to include required data described in the second signal S62. In other words, the system-level cache 620 can send the third signal S63 when a “cache miss” event occurs.

The fourth signal S64 can be used to inform the memory controller 630 which one of the first memory rank rank0 and the second memory rank rank1 is to be accessed before the memory controller 630 receives the third signal S63. The third signal S63 can contain an address of data in the first memory rank rank0 or the second memory rank rank1 to be accessed by the memory controller 630.

In FIG. 6, the fourth signal S64 can be generated by the external memory interface 610 according to the first signal S61. In FIG. 7, the fourth signal S64 can be generated by the master device 105.

In summary, as shown in FIG. 1 to FIG. 7, by informing the external memory interface and/or the memory controller which one of the first memory rank rank0 and the second memory rank rank1 is to be accessed before the memory controller receives the signal containing an address of data in the first memory rank rank0 or the second memory rank rank1 to be accessed, the memory rank to be accessed is enabled in advance. Hence, the operation latency is reduced, and power consumption is better managed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory system comprising:
a central external memory interface configured to convert a first signal from a master device to a second signal, the central external memory interface comprising a first terminal coupled to the master device and configured to receive the first signal, and a second terminal configured to send the second signal;
a system-level cache configured to store data to be accessed according to the second signal, the system-level cache comprising a first terminal coupled to the central external memory interface and configured to receive the second signal, a second terminal configured to send a third signal corresponding to the second signal, and a third terminal configured to send a fourth signal corresponding to the second signal;
a channel external memory interface configured to generate a fifth signal according to at least the third signal, the channel external memory interface comprising a first terminal coupled to the system-level cache and configured to receive the third signal, and a second terminal configured to send the fifth signal; and
a memory controller configured to send a control signal to enable one of a first memory rank and a second memory rank to enter a standby mode and perform a clock synchronization operation before accessing memory data by the memory controller, the memory controller comprising a first terminal coupled to the channel external memory interface and configured to receive the fifth signal, a second terminal coupled to the system-level cache and configured to receive the fourth signal, and a third terminal coupled to the first memory rank and the second memory rank and configured to send the control signal according to the fourth signal;
wherein the fourth signal is used to inform the memory controller which one of the first memory rank and the second memory rank is to be accessed before the memory controller receives the fifth signal, and the fifth signal contains an address of data in the first memory rank or the second memory rank to be accessed by the memory controller.

2. The memory system of claim 1, wherein the system-level cache sends the third signal and the fourth signal when the data stored in the system-level cache fails to include required data described in the second signal.

3. The memory system of claim 1, wherein:
the channel external memory interface further comprises a third terminal coupled to the system-level cache and configured to receive the fourth signal;
the fourth signal is further used to inform the channel external memory interface which one of the first memory rank and the second memory rank is to be accessed; and
the fifth signal is generated according to the third signal and the fourth signal.

4. The memory system of claim 1, wherein the first memory rank and the second memory rank are embedded in a dynamic random-access memory.

5. A memory system comprising:
a central external memory interface configured to convert a first signal from a master device to a second signal and a third signal, the central external memory interface comprising a first terminal configured to receive the first signal, a second terminal configured to send the second signal, and a third terminal configured to send the third signal;
a system-level cache configured to store data to be accessed according to the second signal, the system-level cache comprising a first terminal coupled to the central external memory interface and configured to receive the second signal, and a second terminal configured to send a fourth signal corresponding to the second signal;
a channel external memory interface configured to generate a fifth signal according to at least the fourth signal, the channel external memory interface comprising a first terminal coupled to the system-level cache and configured to receive the fourth signal, and a second terminal configured to send the fifth signal; and
a memory controller configured to send a control signal to enable one of a first memory rank and a second memory rank to enter a standby mode and perform a clock synchronization operation before accessing memory data by the memory controller, the memory controller comprising a first terminal coupled to the channel external memory interface and configured to receive the fifth signal, a second terminal coupled to the central external memory interface and configured to receive the third signal, and a third terminal coupled to the first memory rank and the second memory rank and configured to send the control signal according to the third signal;
wherein the third signal is used to inform the memory controller which one of the first memory rank and the second memory rank is to be accessed before the memory controller receives the fifth signal, and the fifth signal contains an address of data in the first memory rank or the second memory rank to be accessed by the memory controller.

6. The memory system of claim 5, wherein the system-level cache sends the fourth signal when the data stored in the system-level cache fails to include required data described in the second signal.

7. The memory system of claim 5, wherein:
the channel external memory interface further comprises a third terminal coupled to the central external memory interface and configured to receive the third signal;
the third signal is further used to inform the channel external memory interface which one of the first memory rank and the second memory rank is to be accessed; and
the fifth signal is generated according to the fourth signal and the third signal.

8. The memory system of claim 5, wherein the first memory rank and the second memory rank are embedded in a dynamic random-access memory.

9. A memory system comprising:
a central external memory interface configured to convert a first signal from a master device to a second signal, the central external memory interface comprising a first terminal configured to receive the first signal, and a second terminal configured to send the second signal;
a system-level cache configured to store data to be accessed according to the second signal, the system-level cache comprising a first terminal coupled to the central external memory interface and configured to receive the second signal, and a second terminal configured to send a third signal corresponding to the second signal;
a channel external memory interface configured to generate a fourth signal according to at least the third signal, the channel external memory interface comprising a first terminal coupled to the system-level cache and configured to receive the third signal, and a second terminal configured to send the fourth signal; and
a memory controller configured to send a control signal to enable one of a first memory rank and a second memory rank to enter a standby mode and perform a clock synchronization operation before accessing memory data by the memory controller, the memory controller comprising a first terminal coupled to the channel external memory interface and configured to receive the fourth signal, a second terminal coupled to the master device and configured to receive a fifth signal, and a third terminal coupled to the first memory rank and the second memory rank and configured to send the control signal according to the fifth signal;
wherein the fifth signal is used to inform the memory controller which one of the first memory rank and the second memory rank is to be accessed before the memory controller receives the fourth signal, and the fourth signal contains an address of data in the first memory rank or the second memory rank to be accessed by the memory controller.

10. The memory system of claim 9, wherein the system-level cache sends the third signal when the data stored in the system-level cache fails to include required data described in the second signal.

11. The memory system of claim 9, wherein:
the channel external memory interface further comprises a third terminal coupled to the master device and configured to receive the fifth signal;
the fifth signal is further used to inform the channel external memory interface which one of the first memory rank and the second memory rank is to be accessed; and
the fourth signal is generated according to the third signal and the fifth signal.

12. The memory system of claim 9, wherein the first memory rank and the second memory rank are embedded in a dynamic random-access memory.

13. A memory system comprising:
a system-level cache configured to store data to be accessed according to a first signal from a master device and send a second signal according to the first signal;
an external memory interface coupled to the system-level cache and configured to receive the second signal and send a third signal; and
a memory controller coupled to the external memory interface and configured to receive the third signal and a fourth signal and send a control signal according to the fourth signal to enable one of a first memory rank and a second memory rank to enter a standby mode and perform a clock synchronization operation before accessing memory data by the memory controller;
wherein:
the system-level cache sends the second signal when the data stored in the system-level cache fails to include required data described in the first signal; and
the fourth signal is used to inform the memory controller which one of the first memory rank and the second memory rank is to be accessed before the memory controller receives the third signal, and the third signal contains an address of data in the first memory rank or the second memory rank to be accessed by the memory controller.

14. The memory system of claim 13, wherein the fourth signal is generated by one of the system-level cache and the master device.

15. The memory system of claim 14, wherein the fourth signal is further sent to the external memory interface, and the external memory interface generates the third signal according to the second signal and the fourth signal.

16. A memory system comprising:
an external memory interface configured to receive a first signal from a master device and convert the first signal to a second signal;
a system-level cache coupled to the external memory interface and configured to store data to be accessed according to the second signal and send a third signal according to the second signal; and
a memory controller coupled to the system-level cache and configured to receive the third signal and a fourth signal and send a control signal according to the fourth signal to enable one of a first memory rank and a second memory rank to enter a standby mode and perform a clock synchronization operation before accessing memory data by the memory controller;
wherein:
the system-level cache sends the third signal when the data stored in the system-level cache fails to include required data described in the second signal; and
the fourth signal is used to inform the memory controller which one of the first memory rank and the second memory rank is to be accessed before the memory controller receives the third signal, and the third signal contains an address of data in the first memory rank or the second memory rank to be accessed by the memory controller.

17. The memory system of claim 16, wherein the fourth signal is generated by the external memory interface according to the first signal.

18. The memory system of claim 16, wherein the fourth signal is generated by the master device.
